(19) United States
(12) Patent Application Publication
(10) Pub. No.: US 2014/0324470 A1
(43) Pub. Date: Oct. 30, 2014

(54) INFORMATION PROCESSING DEVICE, INFORMATION PROCESSING METHOD, AND NON-TEMPORARY COMPUTER-READABLE RECORDING MEDIUM WITH PROGRAM RECORDED THEREON

(71) Applicant: Masaharu Hatano, Kanagawa (JP)

(72) Inventors: Masaharu Hatano, Kanagawa (JP); Hideto Fujii, Kanagawa (JP)

(73) Assignee: Masaharu Hatano, Kanagawa (JP)

(21) Appl. No.: 14/270,974

(22) Filed: May 6, 2014

Related U.S. Application Data
(63) Continuation of application No. PCT/JP2012/078676, filed on Nov. 6, 2012.

(30) Foreign Application Priority Data
Nov. 6, 2011 (JP) 2011-242950

(51) Int. Cl. G06F 19/00

(52) U.S. Cl. CPC G06F 19/363; G06F 19/3443
USPC 705/3

(57) ABSTRACT

An information processing device includes a database which mutually associates assessment contents of a plurality of assessment items of a subject of care or an object of care with case information, treatment information or effect information of the subject of care or the object of care as one data set and stores the one data set, a processing unit which derives assessment items of the subject of care or the object of care from the database, a processing unit which refers to the database and derives a subsequent assessment item in accordance with the assessment contents of the previously evaluated assessment item and the input or received assessment, and a processing unit which derives case information, treatment information or effect information of the subject of care or the object of care from the database based on the input or received assessment contents.

### TECHNICAL FIELD

The present invention relates to an information processing device, an information processing method, and a non-temporary computer-readable recording medium with a program recorded thereon pertaining to the care of a subject of care, an object of care or the like.

### BACKGROUND ART

Conventionally, in the field of personal care, the general process of understanding a patient's condition was to ask that patient about his/her condition based on predetermined items in a predetermined order.

As an example that systemized this medical examination by interview, there is the technology disclosed in Patent Document 1.

### PRIOR ART DOCUMENTS

### Patent Documents

[Patent Document 1] Japanese Patent No. 3469086

Nevertheless, when asking a patient about his/her condition based on predetermined items in a predetermined order as described above, it was extremely difficult to identify the detailed symptoms of a subject of care or symptoms that are peculiar to that subject of care. Moreover, even if the symptoms could be identified, the treatment method thereof was entrusted to the ability of the person who prepares the care plan.

Thus, an object of this invention is to provide an information processing device, an information processing method, and a non-temporary computer-readable recording medium with a program recorded thereon capable of easily and accurately identifying symptoms of a subject of care.

### SUMMARY OF THE INVENTION

The information processing device according to one or more embodiments of the present invention includes:

a database which mutually associates assessment contents of a plurality of assessment items of a subject of care or an object of care with case information, treatment information or effect information of the subject of care or the object of care as one data set and stores the one data set;

a first processing unit which derives an assessment item of the subject of care or the object of care from the database;

a second processing unit which refers to the database and derives a subsequent assessment item in accordance with the assessment contents of the previously evaluated assessment item and the input or received assessment; and

a third processing unit which derives case information, treatment information or effect information of the subject of care or the object of care from the database based on the input or received assessment contents.

According to one or more embodiments of the present invention, assessment can be efficiently and accurately performed since assessment is not performed according to predetermined contents and order, but performed rather in a manner that is appropriate for the subject of care or the like.

In the present invention, the database may store, for each data set, assessment contents, order of the assessment items that were evaluated, and a logic circuit for making decisions.

According to one or more embodiments of the present invention, since assessment contents, order of the assessment items that were evaluated, and a logic circuit for making decisions are respectively associated for each data set, other related information can be acquired as the same data set by inputting any one of the information.

In one or more embodiments of the present invention, when contents of a same assessment item are stored in the database, case information or treatment method of the subject of care or the object of care corresponding to the contents of that assessment item is extracted, and, when contents of a same assessment item are not stored in the database, case information or treatment method corresponding to contents of an assessment that is approximate to the contents of that assessment item is extracted.

According to one or more embodiments of the present invention, the case information or treatment method can be derived based on estimation from approximate information even without a data set including the same data.

According to one or more embodiments of the present invention, it is possible to further include estimation means which estimates anticipated assessment contents based on the input or received case information, treatment information or effect information. According to the present invention, there is an advantage of being able to present directionality of new information processing of estimating assessment information based on case information or the like.

According to one or more embodiments of the present invention, when the case information, treatment information or effect information derived based on the assessment contents and the actual case information, treatment information or effect information that was input or received are different, the actual case information, treatment information or effect information that was input or received may be stored in the database. According to the present invention, it is possible to improve the accuracy and precision of the database, and cause the database to evolve on its own.

The information processing method according to one or more embodiments of the present invention includes:

a step of a first processing unit deriving an assessment item of a subject of care or a object of care from a database which mutually associates assessment contents of a plurality of assessment items of the subject of care or the object of care with case information, treatment information or effect information of the subject of care or the object of care as one data set and stores the one data set;

a step of a second processing unit referring to the database and deriving a subsequent assessment item in accordance with the assessment contents of the previously evaluated assessment item and the input or received assessment; and a step of a third processing unit deriving case information, treatment information or effect information of the subject of care or the object of care from the database based on the input or received assessment contents.

According to one or more embodiments of the present invention, assessment can be efficiently and accurately performed since assessment is not performed according to predetermined contents and order, but performed rather in a manner that is appropriate for the subject of care or the like.

The non-temporary computer-readable recording medium with a program recorded thereon according to one or more embodiments of the present invention causes a computer to execute:

a first step of a first processing unit deriving an assessment item of a subject of care or an object of care from a database which mutually associates assessment contents of a plurality of assessment items of the subject of care or the object of care with case information, treatment information or effect information of the subject of care or the object of care as one data set and stores the one data set;

a second step of the second processing unit referring to the database and deriving a subsequent assessment item in accordance with the assessment contents of the previously evaluated assessment item and the input or received assessment; and

a third step of the third processing unit deriving case information, treatment information or effect information of the subject of care or the object of care from the database based on the input or received assessment contents.

According to one or more embodiments of the present invention, assessment can be efficiently and accurately performed since assessment is not performed according to predetermined contents and order, but performed rather in a manner that is appropriate for the subject of care or the like.

The database system according to one or more embodiments of the present invention is a database system connected to first to third processing units:

wherein the first processing unit executes:

a first step of the first processing unit deriving an assessment item of a subject of care or an object of care from a database which mutually associates assessment contents of a plurality of assessment items of the subject of care or the object of care with case information, treatment information or effect information of the subject of care or the object of care as one data set and stores the one data set;

a second step of the second processing unit referring to the database and deriving a subsequent assessment item in accordance with the assessment contents of the previously evaluated assessment item and the input or received assessment; and

a third step of the third processing unit deriving case information, treatment information or effect information of the subject of care or the object of care from the database based on the input or received assessment contents,

wherein the database system includes update means which updates the assessment contents of the previously evaluated assessment item and the input or received assessment, reply order of the assessment contents stored in the database, and the actually input case information, treatment information or effect information.

According to one or more embodiments of the present invention, assessment can be efficiently and accurately performed since assessment is not performed according to predetermined contents and order, but performed rather in a manner that is appropriate for the subject of care or the like. Moreover, since an update means is provided, it is possible to cause the database system to automatically evolve.

The object of care described above is a concept including life forms such as animals and plants.

The first to third processing units may be configured from the same arithmetic device, or configured from separate arithmetic devices.

Case information is information related to the symptoms of the subject of care or the object of care, treatment information is information related to the treatment of the subject of care or the object of care such as the treatment policy or the treatment method, and effect information is information indicating the effectiveness of the treatment method, treatment policy or the like.

### BRIEF DESCRIPTION OF THE DRAWINGS

FIG. 1 is an explanatory diagram of the care management model.

FIG. 2 is an explanatory diagram of the care management model.

FIG. 3 is an explanatory diagram of the care management model.

FIG. 4 is an explanatory diagram of the logic gate.

FIG. 5 is an explanatory diagram of an example of the logic circuit.

FIG. 6 is a diagram schematically showing the information processing system including the information processing device.

FIG. 7 is a diagram showing a concept of the (D)F-PDCA cycle of the care management system.

FIG. 8 is a diagram showing a concept of the information processing cycle.

FIG. 9 is a diagram explaining the input/output of information processing.

FIG. 10 is a diagram schematically showing the database.

FIG. 11 is a diagram explaining the basic processing flow of information processing.

FIG. 12 is a diagram explaining the derivation algorithm of the treatment information.

FIG. 13 is a diagram explaining the derivation flow of assessment items.

FIG. 14 is a diagram schematically showing a modified example of the information processing device.

### BEST MODE FOR CARRYING OUT THE INVENTION

The preferred embodiments of the present invention are now explained with reference to the drawings.

1. Background Information

The present inventors considered that a caregiver who possesses the combination of realistic principles of mental care and principles of dealing with people is a person who can sympathize (kyomei) with the sensation and world of persons with dementia. In addition, the present inventors hypothesized that dementia care is a method of attempting to lead the dementia patient toward stability, and created a care method referred to as “Kyomation Care”.

Kyomation Care is a coined term by deeming the care based on the combination of realistic principles of mental care and principles of dealing with people as sympathy (kyomei).

Furthermore, Kyomation Care is defined as the practice of care based on assessment, care plan and interpersonal assistance techniques that are supported by fundamental medical science, nursing science and caring science. Since it is difficult to read the complex and intricate responses of persons suffering from dementia, Kyomation Care modularized (functionally accumulated) the algorithms (procedures for resolving problems) obtained from a person's gestures and behavior as information communication media. In addition, data is sorted by being projected on the logic circuits (AND, nAND, OR, nOR) of a computer to classify data in a specific order, and a simulation for obtaining the statistics thereof is performed to verify the data.

It is said that, in order to care for dementia, it is necessary to correctly understand the generation mechanisms of the various symptoms suffered by patients of dementia.

This is because each symptom involves a corresponding abnormality of the brain function. If it is possible to understand that the various symptoms suffered by patients of dementia are not some incomprehensible, perplexing behavior, it could be said that scientific measures and care based on reasoning will be possible.

Accordingly, the sharing of medical, nursing and caring information is essential and, in order to improve the quality of dementia care, physicians, nurses, caregivers, physical therapists, occupational therapists, speech therapists, acupuncturists, judo therapists and others need to understand the purpose related to the care, set specific goals for the mental care, and engage in “rational care”.

Moreover, in order to ensure quality in dementia care, comprehensive assessment that covers all areas including objectivity, adequacy, reliability, and feasibility is also required.

Nevertheless, it is said that the succession of “awareness” based on on-site knowledge and skills is extremely difficult. Under these circumstances, it is difficult to gather the required information, and the actual state is that this is creating problems for persons in charge of creating care plans. Since much time is required for exhaustively collecting and comprehending information, and more time is required in conferences for communicating and sharing information, it is often the case that clarification (needs) of extraction of tasks, which is the original objective, and examination of service contents for achieving such tasks, fall short, and it can be said that, under the current circumstances, it is difficult to complete care conferences within a predetermined period of time.

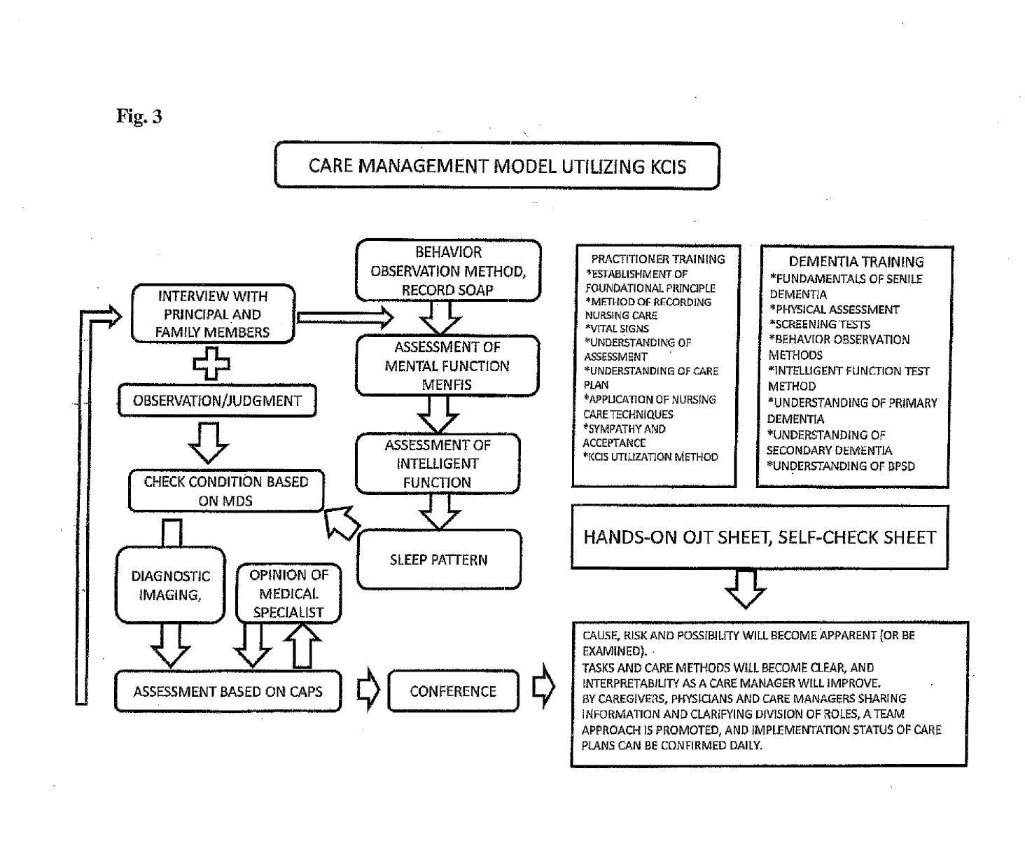

With the care management system (Kyomation Care) shown in FIG. 3, in order to resolve the foregoing problems, KCIS (Kyomation Care Interface System) was developed by organizing follow-up nursing care records (approximately 8,000,000 data) across a period of 10 years of persons suffering from dementia and cases examples of over 300 dementia patients in order to alleviate the sense of burden at the scene and reasonably realize comprehensive assessment and the care management cycle (assessment→determination→creation of care plan→provision of care→assessment).

The features of KCIS are organized and systemized by incorporating the following six contents so that objective information can be collected even from persons suffering from dementia who have no subjective symptoms.

(1) Adoption of nursing care records based on the SOAP system (problem-oriented Description System)

(Subjective . . . subjective symptoms: What the person said)

(Objective . . . objective findings: What was observed)

(Assessment . . . state assessment: Impression)

(Plan . . . plan: What was performed)

(2) Basic observation is performed using the modules of the 13 (state observation) items

1 attitude, 2 expression, 3 attire, 4 behavior, 5 verbal comprehension, 6 articulatory disorder, 7 memory loss, 8 impaired orientation, 9 thinking, 10 calculation, 11 judgment, 12 emotion, 13 desire

(3) Mental Function Impairment Scale MENFIS: Drug efficiency and loss of sanity are assessed based on “cognitive function”, “motivation function” and “emotional function”

(4) Sleep/defecation pattern: Sleep/defecation pattern is graphically represented to clarify the life rhythm

(5) Intellectual function examination and behavioral observation assessment are periodically conducted

(6) RDR (Retrospective Date Research): Pathology is organized from the following 10 items. State assessment of pathology and daily life situation to date is acquired through interviews with the patient and family members in advance

1 life history, 2 family structure, 3 initial symptoms, 4 manner of onset, 5 personality prior to illness, 6 personality change after illness, 7 history of illness, 8 negative genetic factors, 9 physical complications, 10 hobbies/preferences

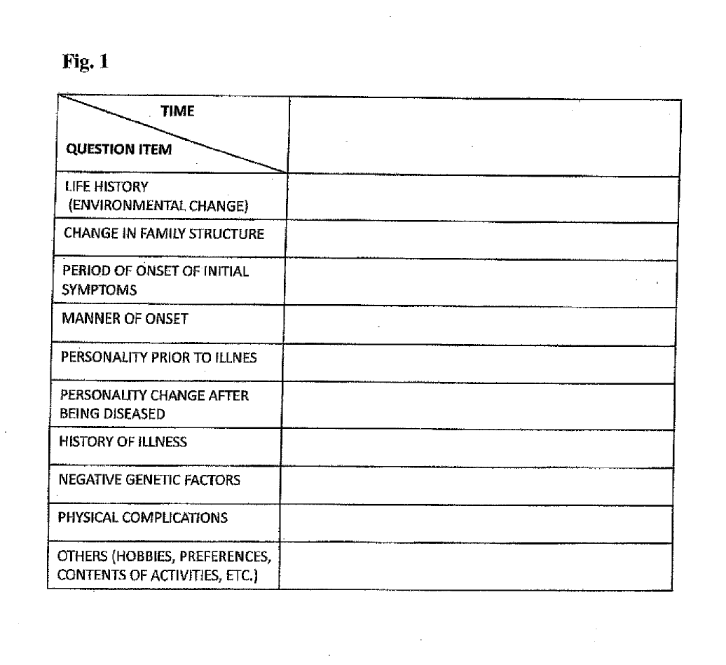

With Kyomation Care, clinical histories are organized with RDR (Retrospective Date Research) as shown in FIG. 1. RDR is an interview of the foregoing 10 items in Q&A format based on the patient's recollection in chronological order. Sufficient consideration shall be given to the questions in view of the influence that the questions will have on the psychology of family members.

KCIS is a system that can reflect the foregoing information, for instance, in the assessment items of MDS (Inter Rai). The care manager can thereby create a tentative plan based on the Caps/Raps guidelines while mixing the triggered problem areas, results of the image diagnosis, and information of the various therapists and others. Moreover, persons concerned such as physicians, nurses and caregivers can coordinate and engage in care conferences on a network using ICT (Information Communication Technology).

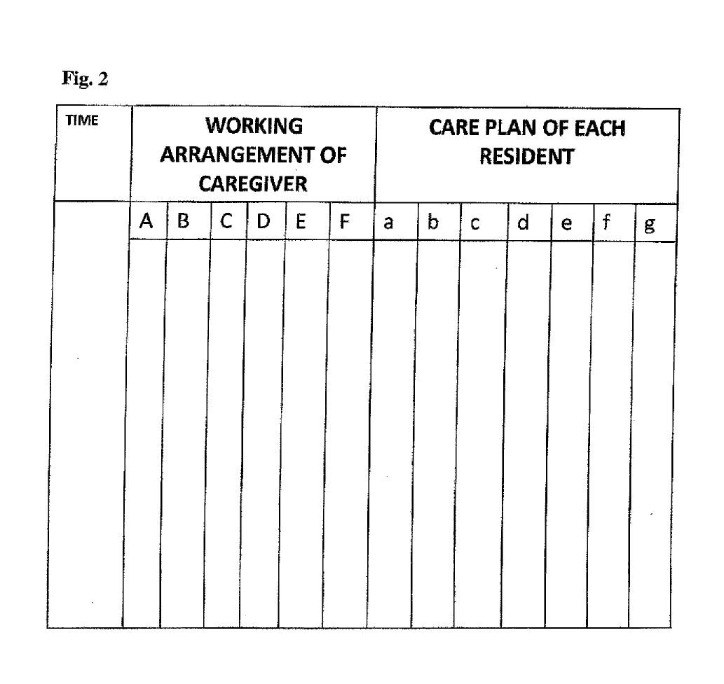

Based on the above, it is possible to comprehensively extract the tasks by utilizing expertise from the preferences, life history and condition of brain function of persons suffering from dementia, and verbalize in detail, in the care plan, the scientific measures to be taken for achieving the tasks and contents for supporting the life of such persons through medical care. In addition, in order to increase the execution rate of the care plan and alleviate the workload, the time management cycle (call sheet) shown in FIG. 2 was developed.

The time management cycle (call sheet) is a medical version of a table referred to as a call sheet, which is used on site in theaters to inform the cast when they are to appear and show the overall program, in order to utilize the MDS (Minimum Data Set) and organize the care plan based on multilateral assessment and objective information, and so that the professional caregivers and others can fulfill their roles according to the care plan needs so as to provide services that match the care plan. This time management cycle may also be stored in the database.

Moreover, in order to realize better care management, by utilizing KCIS (recording operation), it is possible to increase the awareness as a caregiver and offer an aspect as an educational application function so that knowledge and skills can be mastered, and physicians, caregivers, nurses, physiotherapists, occupational therapists speech therapists, care managers and others can thereby share information and clarify their division of roles, whereby the effect of promoting a team approach is attained.

In addition, since the method of dealing with persons suffering from dementia is never unidirectional, the system may be designed so that the MDS (Inter Rai) is ultimately used for reconfirmation so as to re-acknowledge that the method of dealing with dementia patients is constantly a relation of interaction and bidirectional involvement.

The embodiment of the present invention is a system (KCIS: Kyomation Care Interface System) that utilizes a computer to reasonably realize comprehensive assessment and the care management cycle (assessment→determination→creation of care plan→provision of care→assessment), and enables the comprehensive support based on networking using ICT (Information Communication Technology).

2. Basic observation items

For example, the basic observation items are now explained taking the determination of the advancement of dementia as an example.

With regard to the screening test, which is an extremely important and indispensible test for determining the advancement of dementia, the determination is not made at a specific point in time, and it is important to follow the development. While a screening test is first and foremost used as an auxiliary means for determining dementia, hints for care can be obtained by utilizing the screening test in dementia care.

For example, when there is a person suffering from dementia whose desires are deteriorating, screening can be performed to assess whether such deterioration in desires is caused by aging, depression or dementia itself.

Contrarily, making comments based on the screening test are sometimes effective for maintaining the ADL (Activities of Daily Living) or alleviating the advancement of dementia.

A screening test can be broadly classified into an “intellectual function examination method” and a “behavioral observation method (behavior assessment method)”. Moreover, the screening test performed to persons with dementia is based on the premise of performing multilateral assessment by combining both of the foregoing methods, rather than only performing one method.

The screening test is an extremely important auxiliary means for diagnosis upon understanding persons with dementia and creating appropriate measures to care for such persons.

Nevertheless, while the intellectual function examination method is superior for objective assessment, the burden on a person suffering from dementia is greater than expected. Moreover, it is often the case that the intellectual function examination method cannot be performed in cases of deliria or severe dementia.

Meanwhile, while the burden of the behavioral observation method (behavior assessment method) is lighter on a person suffering from dementia, in many cases the determination is biased because the determination is dependent on the caregiver's subjective assessment.

Thus, with the care (Kyomation Care) invented by the present inventors, dementia can be multilaterally assessed by combining the “intellectual function examination method” and the “behavioral observation method” while examining the burden level of the caregiver.

In addition, the present inventors created a care management method that aims to become a partner (reliable person) to share the time and space with persons with dementia by building up objective observation and awareness, and sharing information.

One such method is the 13 state observation items that enable the alleviation of the dementia symptoms by utilizing and applying the intellectual function examination method and the behavioral observation method.

The 13 basic observation items aim to predict and alleviate maladjusted behavior such as Behavioral Psychological Symptoms of Dementia (BPSD) by confirming the underground resources (remaining ability) coinciding with the advancement and the self-care ability as the communication ability from the behavior of the person suffering from dementia. Here, the term “self-care ability” refers to the ability of operations and procedures that can be independently executed by using his/her remaining abilities such as the underground resources (remaining ability) and communication ability.

It is possible to assess the self-care ability, find the rebuilding of living, and elicit the possibility of care from the information obtained from the 13 basic observation items. In addition, the 13 basic observation items will become assessment tools for encouraging and supporting patients according to the plan for alleviating the Behavioral Psychological Symptoms of Dementia (BPSD).

Upon caring for persons with dementia, while there are differences based on the type or level of pathology, it is said that the caregiver is facing difficulty in interpersonal assistance.

In many cases, caregivers are caring for patients while encountering anxiety or fear from not knowing how to deal with, talk to, or become involved with persons with dementia.

Moreover, due to preconceptions or biased impressions of dementia, there are cases where the caregivers deal with the situations from their perspective upon encountering incomprehensible conditions or enigmatic behavior since these can only be viewed as strange phenomena.

Thus, by fully understanding the workings of the brain and its mechanism, it is necessary to view an incomprehensible state of confusion also as a pathology that is based on a brain dysfunction.

An incomprehensible state of confusion or the like is also considered to be a defensive reaction that comes from poignant anxiety. As a manner of dealing with persons with dementia described above, while stability is yielded simply by dealing with the patients calmly and quietly, many caregivers have experienced generating Behavioral Psychological Symptoms of Dementia (BPSD) of anxiety or confusion as a result of issuing orders or taking a manipulative attitude.

This is because no specific methods have been presented for dealing with dementia patients, and therefore the caregivers adopt a nursing method that is mainly based on their experimental rules. Thus, uniform care is not performed, and it is not possible to improve the quality of care.

The Kyomation Care developed by the present inventors is a care management method that was developed in order to resolve the foregoing problems.

In order to achieve the foregoing care management method, it is necessary to understand the workings of the brain and the pathology mechanism thereof in order to understand the characteristics of dementia.

The unique and incomprehensible sensation and imagination of persons with dementia are the secret of being able to live even with an atrophied brain, and these can also be considered a self-care ability, and reversibility of the brain. In addition, it could be said that involvement based on scientific measures that coincide with the reasoning of dementia is the desirable method of dealing with the patients that will contrarily offer calmness and sense of security.

The 13 basic observation items not only assist in comprehending the condition of persons with dementia, they also lead to confirming the self-care ability such as underground resources (remaining ability) and communication ability. That is, rather than understanding which part of the brain is related to the behavior and expression based on the 13 basic observation items and seeking answers for care while depending on experimental rules, it is necessary to assess and record the self-care ability of each and every patient, share the information of individual measures of each and every patient, and thereby perform uniform care.

In any case, there is no doubt that the equalization of quantity and quality of dealing with persons with dementia will have a great impact on the QOL. While it is not possible to stand in the place of a person with dementia, maladjusted behavior such as Behavioral Psychological Symptoms of Dementia (BPSD) can be eliminated by leveraging the professional creativity and sharing information, and the possibility of finding a way to rebuild the patient's life can be considered from the 13 state observation items by encouraging and supporting the patient for increasing adaptive behavior.

When there are 13 types of assessment items, even if the answer is a multiple choice from two answers, the combination of assessment answers will exceed 6 billion combinations. Accordingly, this number of combinations corresponds to the entire population on earth.

3. Application of logic circuits

The present inventors discovered algorithms (procedures for resolving problems) obtained from the gestures and behavior of the other party by applying logic circuits of a computer similar to the synapse transmission method. In addition, data was classified by being projected on the logic circuits of the computer, and the reactions were read from gestures and attitudes, and the care plan was devised via hypothesis thinking.

A logic circuit is operated with the two values of 1 and 0. The 10 types of communication based on the foregoing attitude of persons suffering from dementia are applied to the logic circuit image (1=Yes) (0=No), and observed. A logical AND is a gate that outputs 1 only when 1 is input to all input terminals, a non-conjunction nAND is a gate that outputs 0 only when 1 is input to all input terminals, a logical OR is a gate that outputs 1 when 1 is input to at least one input terminal, and a logical nOR is a gate that outputs 0 when 1 is input to at least one input terminal.

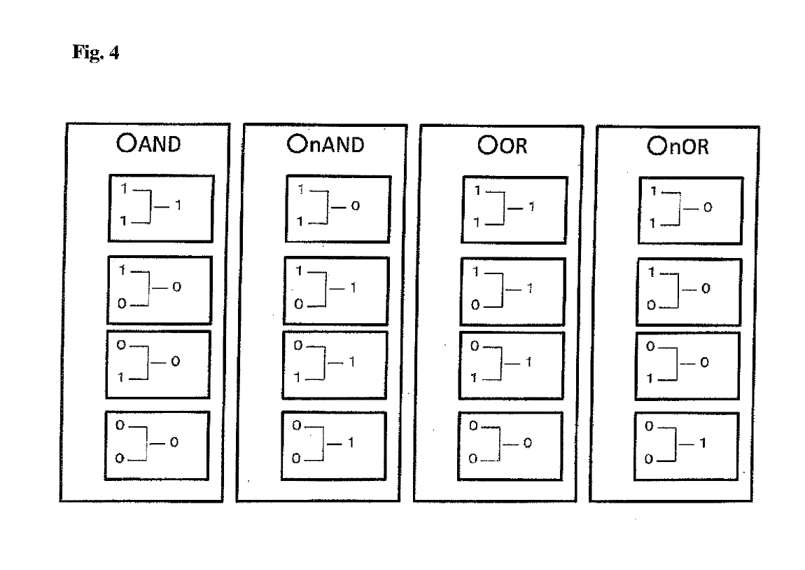

The present inventors discovered that the logic circuits can come up with a method of attempting to alleviate the symptoms upon competently entering the world of persons suffering from dementia and assisting such persons toward stability upon hypothesizing that the expression of the Behavioral Psychological Symptoms of Dementia (BPSD) can be suggested based on the combination of the four types of logic circuits; namely, AND, nAND, OR, and nOR, shown in FIG. 4.

An example of observing the state using AND, nAND, OR, and nOR (Ms. A, 86 years of age, female, independence degree of daily living A-1, demented elderly independence degree of daily living III, Alzheimer-type dementia AtD) is shown below.

When Ms. A was having breakfast, she picked up her dishes and stood up without a word, headed for the sink, rolled up her sleeves, and started washing her dishes. Once Ms. A finished washing the dishes, she wiped the dishes with a towel, and took up and started washing the dishes of the lady next to her who was acting clumsy. When the caregiver who was watching Ms. A's smooth movement said, “Ms. A, you've done a great job today”, Ms. A got wound up and angry and said, “Do you have a problem? What, you don't think I can wash the dishes?!”

Upon observing Ms. A's attitude chronologically, her first behavior was to roll up her sleeves and start washing the dishes. It is possible to observe Ms. A's executive function and curiosity (interest) in dishwashing. Moreover, Ms. A's subsequent behavior was to take up and start washing the dishes of the lady next to her who was acting clumsy. It could be said that this behavior is a clear state of understanding the surrounding situation and attempting to resolve the problem. Since Ms. A showed curiosity and her way of thinking was clear, it is hypothesized that a sense of accomplishment has been obtained from the logical AND circuit.

Nevertheless, while a sense of accomplishment has been obtained, it could be said that Ms. A was unable to understand the subtle nuance of the expression used by the caregiver, became protective, and expressed an attitude where her self-respect was hurt. While this can also be estimated from the independence degree of daily living A-1 and demented elderly independence degree of daily living III, the existence of a logical nOR circuit can be observed.

Moreover, upon hypothesizing that Ms. A showed symptoms of BPSD of getting wound up in response to the caregiver's comment due to problems with verbal comprehension, a non-conjunction nAND circuit can also be observed.

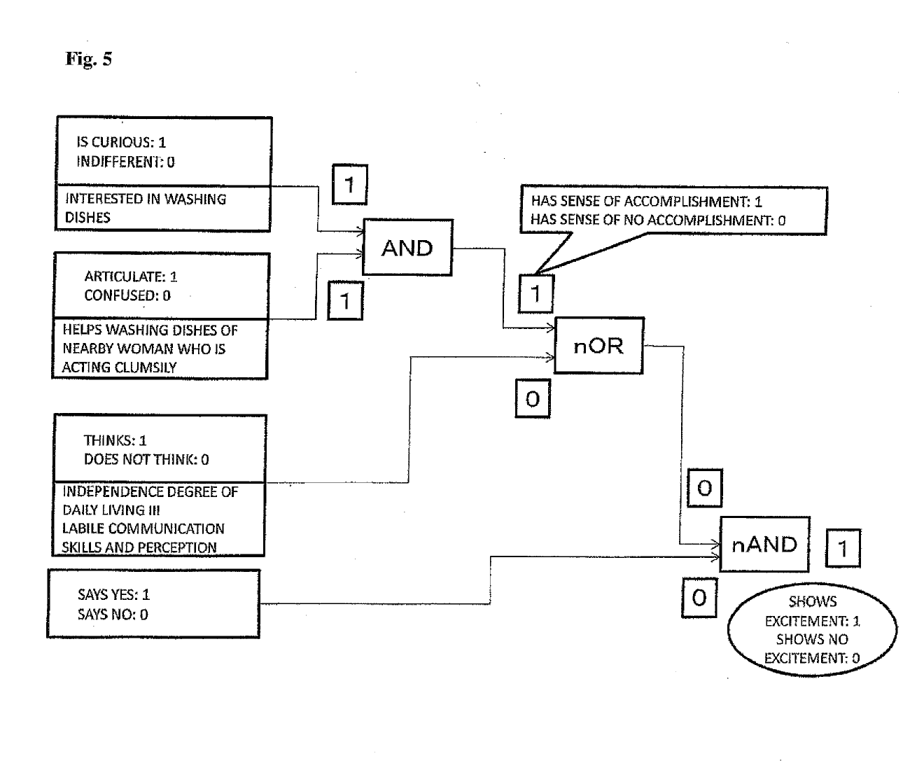

A summary of the series of logic circuits is shown in FIG. 5. This logic circuit is first and foremost the logic circuit that is estimated from Ms. A's attitude of her daily life, and does not represent her personality or ideals. This way of thinking is the concept (care skill) of using the logic circuit, which is the scheme of the neurotransmission of the brain, and derives the circuit that thinks about Ms. A's matters from her behavior (attitude) and utilizes it in the care.

In addition, performed was individual care of understanding Ms. A's judgment and expressiveness of minding the caregiver's comment, sharing the gratification of the sense of accomplishment, and, rather than persuading Ms. A to understand the caregiver's comment, Ms. A was convinced and taught to say “Thank you” and “bow” with a sense of respect at all times based on the clarity of resolving the problem. Consequently, Ms. A's agitation was alleviated, and eventually disappeared.

By assessing the patient based on sound logic according to the conditions of each individual as described above, it is possible to appropriately understand the condition of the subject of care or the like. Moreover, it is also extremely useful to apply this logic circuit for the assessment of others.

It is difficult for persons suffering from dementia to sometimes understand words due to their deterioration in verbal comprehension and, since their vocabulary also decreases, they tend to use pronouns such as “that . . . ” “those . . . ” “this . . . ” and “it . . . ”, but it becomes possible to determine that the pronouns such “that . . . ” and “this . . . ” respectively mean “I'm hungry” and “I want to use the restroom” as that person's precise expression.

Since persons suffering from dementia are often inept at keeping pace with the caregiver, by the caregiver matching the contents and speed of their conversation with a patient and closely observing the vocabulary and expressions based on the 13 state observation items, it becomes possible to understand the pace of that patient. In addition, the caregivers can mutually share their information and cater to the patient's wishes.

To devise a care plan based on the information obtained from the 13 state observation items, learn the workings of the mind and assess the living ability of that patient, and recognize care that maximizes the self-care ability (underground resources) will become a reference in flexibly dealing with persons with dementia, and meaningful in the care management system (Kyomation Care).

4. Information processing device

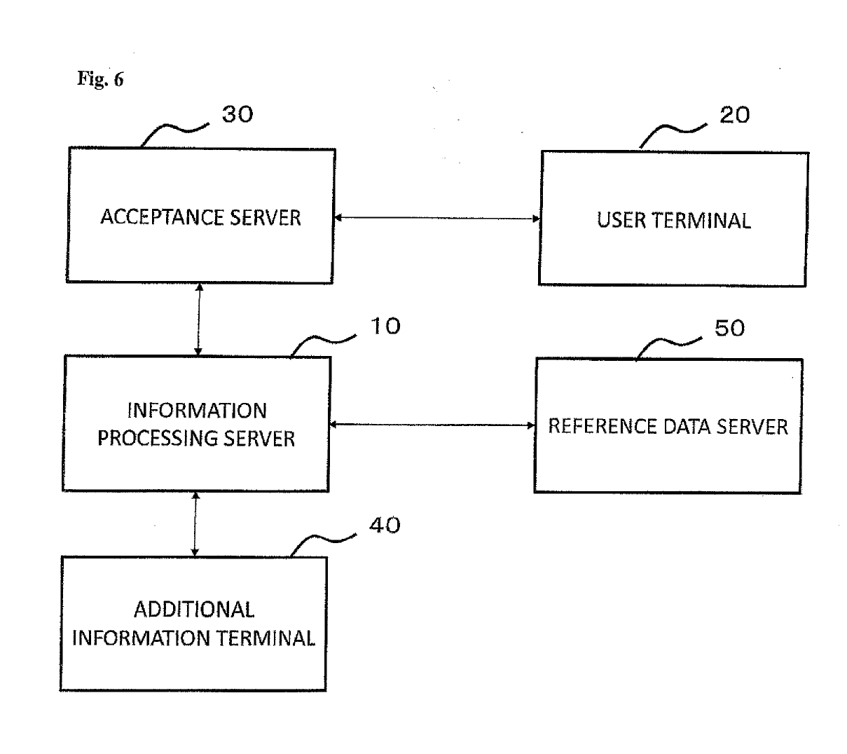

The information processing device 10 is now explained with reference to FIG. 6 to FIG. 13. The information processing device 10 is an example of being connected to an information communication network such as the internet.

The information processing device 10 functions as an information processing server, and sends and receives information to and from a user terminal 20. The information processing device 10 may send and receive information to and from the user terminal 20 via an acceptance server 30 as shown in FIG. 6, or directly send and receive information to and from the user terminal 20. the information processing device 10 may also send and receive information to and from an additional information input terminal 40, of an expert or the like to provide additional information, through an information communication network.

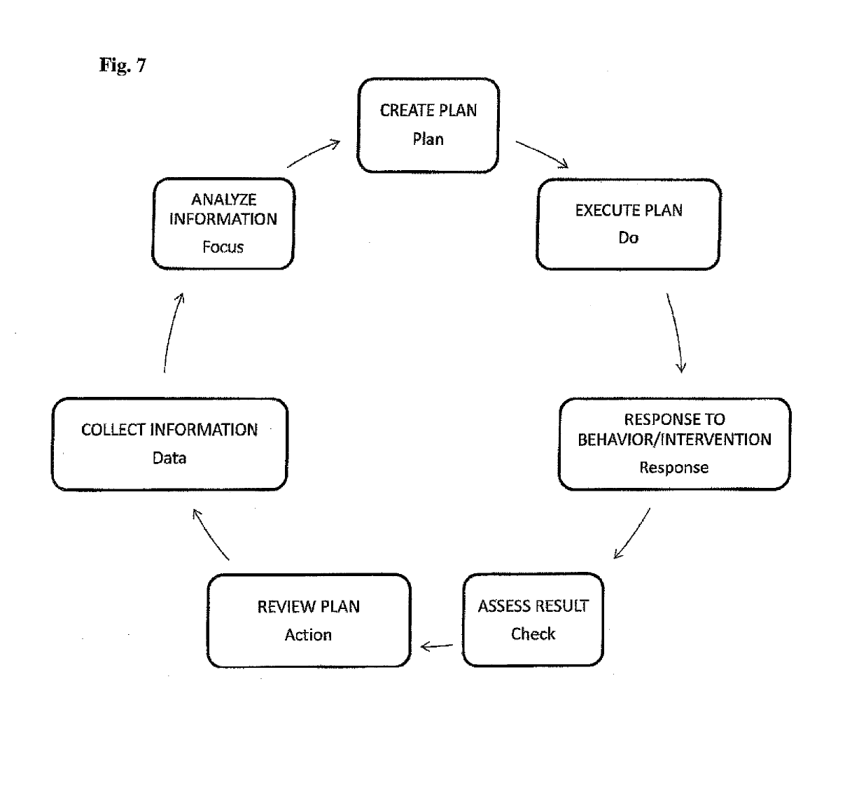

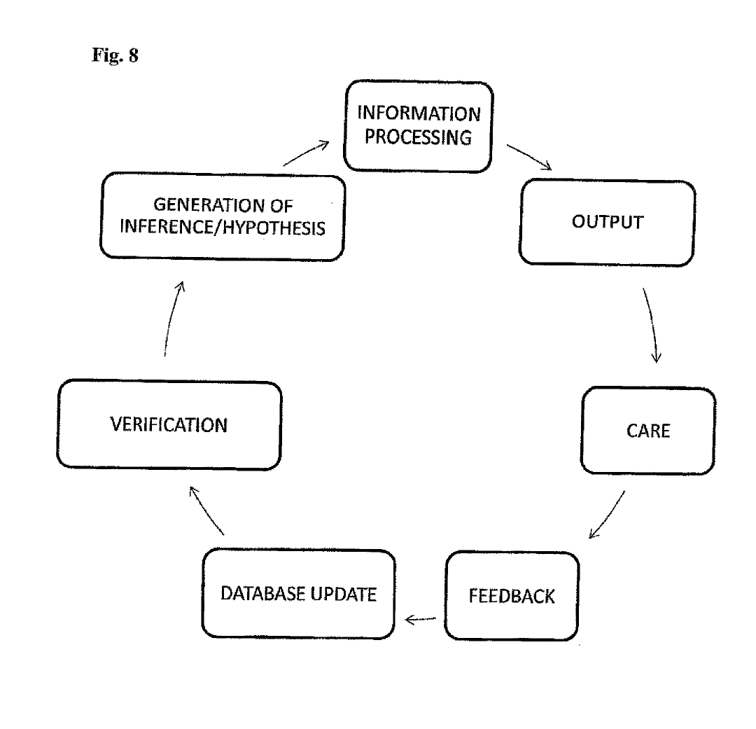

The information processing device 10 is an information processing device for supporting the foregoing care management system (Kyomation Care). Specifically, as shown in FIG. 7, the information processing device 10 is a supporting device for rotating the cycle of “create plan”, “execute plan”, “response to behavior/intervention”, “assess result”, “review plan”, “collect information” and “analyze information” in the field of medical care. By rotating this management cycle, it is possible to simultaneously rotate the cycle shown in FIG. 8; namely, information processing, output, care, feedback, database update, verification, and generation of new inference/hypothesis.

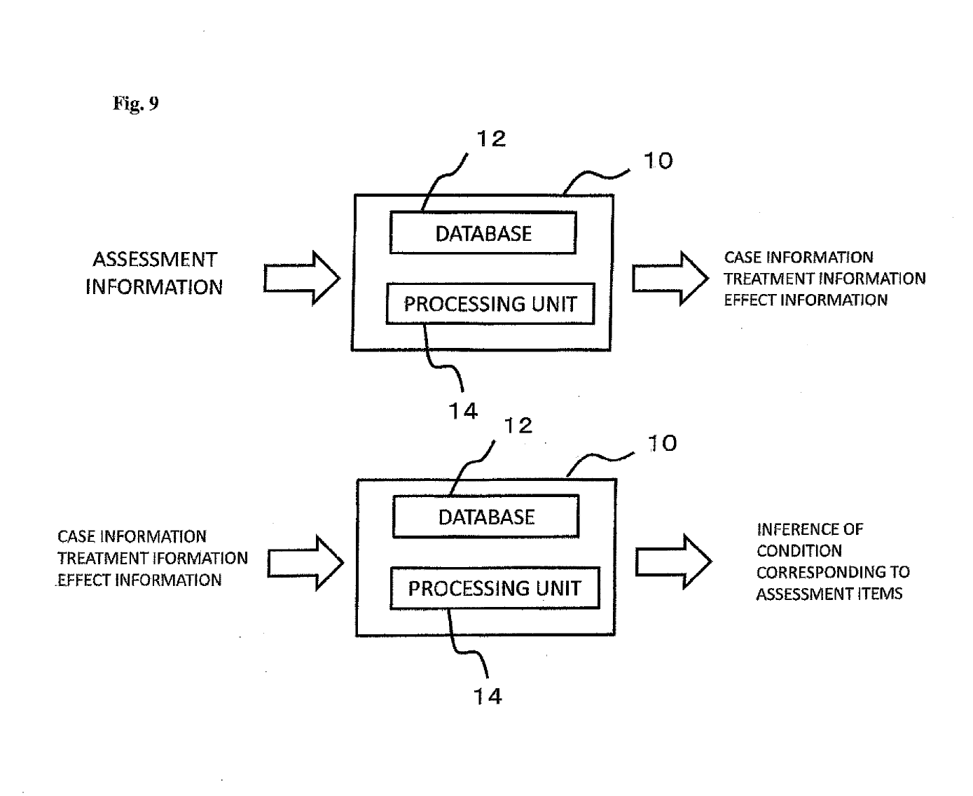

As shown in FIG. 9, the information processing device 10 includes a database 12 and a processing unit 14.

The information processing device 10 includes a function of outputting case information and treatment information from assessment information based on a database, and a function of inferring assessment contents corresponding to assessment items based on case information, treatment information or effect information.

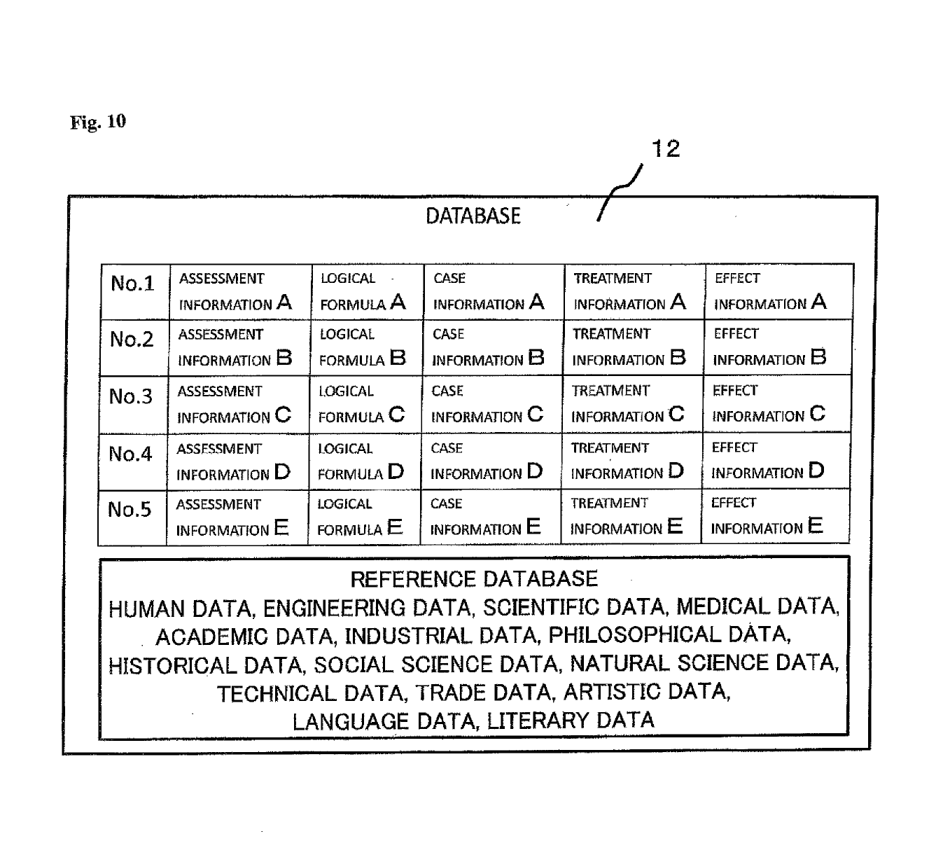

As shown in FIG. 10, the database 12 mutually associates assessment contents of a plurality of assessment items of a subject of care or an object of care with case information, treatment information or effect information of the subject of care or the object of care as one data set and stores the one data set. There is no particular limitation regarding the assessment items so as long as the assessment item enables the identification of symptoms of a subject of care and, for example, the 13 items of attitude, expression, attire, behavior, verbal comprehension, articulatory disorder, memory loss, orientation, thinking, calculation, judgment, emotion, and desire may be considered.

The database 12 stores, for each data set, assessment contents, order of the assessment items that were evaluated, and a logic circuit for making decisions. As the logic circuit, considered may be, for example, a logic circuit that links the assessment contents of the logic circuits (AND, nAND, OR, nOR) shown in FIG. 5, and symptom information or treatment information. As the assessment items, for example, the foregoing basic observation items may be applied. The database is stored in a storage device (for example, ROM, hard disk) included in the information processing device 10.

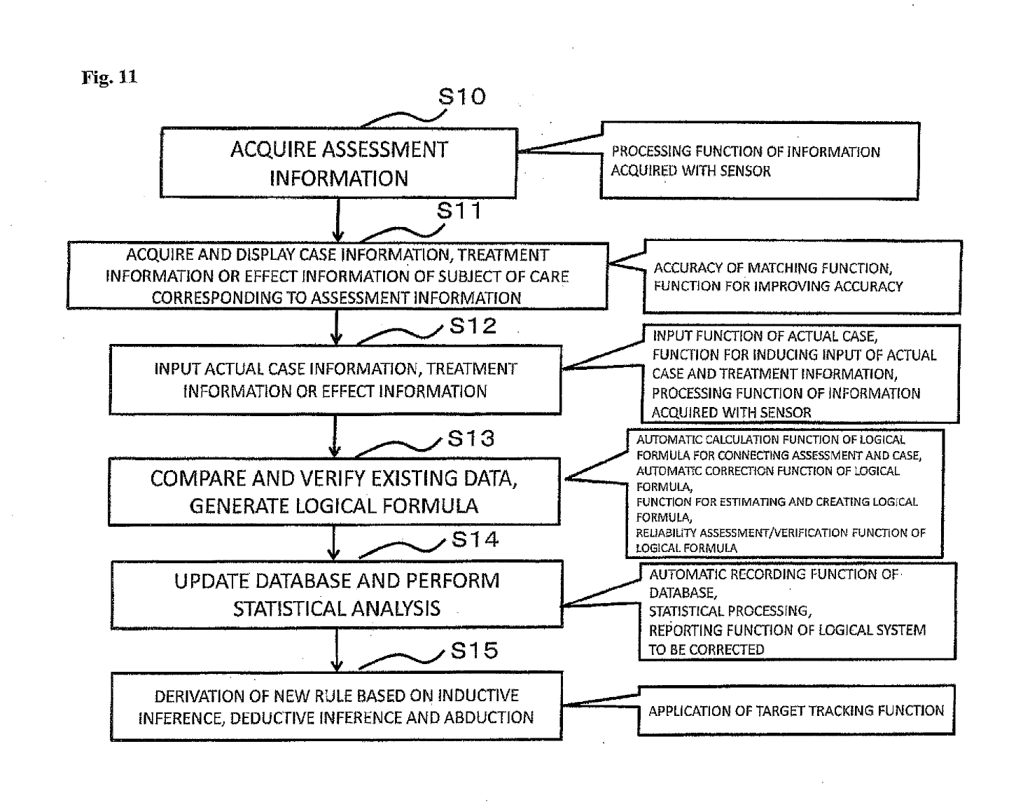

The function of outputting case information, treatment information or effect information from the assessment information based on the database is now explained with reference to FIG. 11.

In accordance with the information (case information, treatment information or effect information) requested by the user information terminal 20, the information processing device 10 foremost acquires the assessment information (S10). In this processing, information acquired with a sensor may be processed.

Subsequently, case information and treatment information of the subject of care or the like corresponding to the assessment information are acquired based on the database (S11). Processing for inference, and improving the accuracy and precision of matching function may also be performed.

Subsequently, the information processing device 10 sends the acquired information to the user terminal 20. The user of the user terminal 20 inputs the actual case information, actual treatment information, and effect information (S12). A function for guiding the input of actual cases and treatment information or effect information and a function for processing the acquired information may also be added.

When the actual case information, treatment information or effect information is received from the user terminal 20, the foregoing received information is compared with existing case information, treatment information or effect information for verification, and a logical expression for linking the assessment information with the case information, treatment information or effect information is generated (S13). Here, automatic calculation processing of the logical expression for linking the assessment and cases, processing for estimating the logical expression, and reliability assessment/verification processing of the logical expression may also be performed.

Subsequently, the database 12 is updated and statistical analysis is performed in order to enhance the data in the database 12 (S14). Here, automatic recording processing of the database 12, statistical processing, and annunciation processing of the logical expression to be corrected may also be performed.

When the received actual treatment information differs from the treatment information that was sent to the user terminal, this means that the sent treatment information is ineffective, but this may be left in the database 12 as ineffective treatment information. Subsequently, the rules of new information processing may be derived based on functional reasoning, deductive inference, hypothesis generation, or the like (S15). Here, there are cases where the goal or target of care of the subject of care or the like may change, and processing of functional reasoning, deductive inference, hypothesis generation, or the like that matches the new target may be performed based on the target tracking function using the cybernetics theory or the like.

The information processing device 10 can acquire the case information and treatment information as follows upon realizing the function of outputting the case information and treatment information from the assessment information based on the database, and the function of inferring the assessment contents corresponding to the assessment items based on the case information, treatment information or effect information.

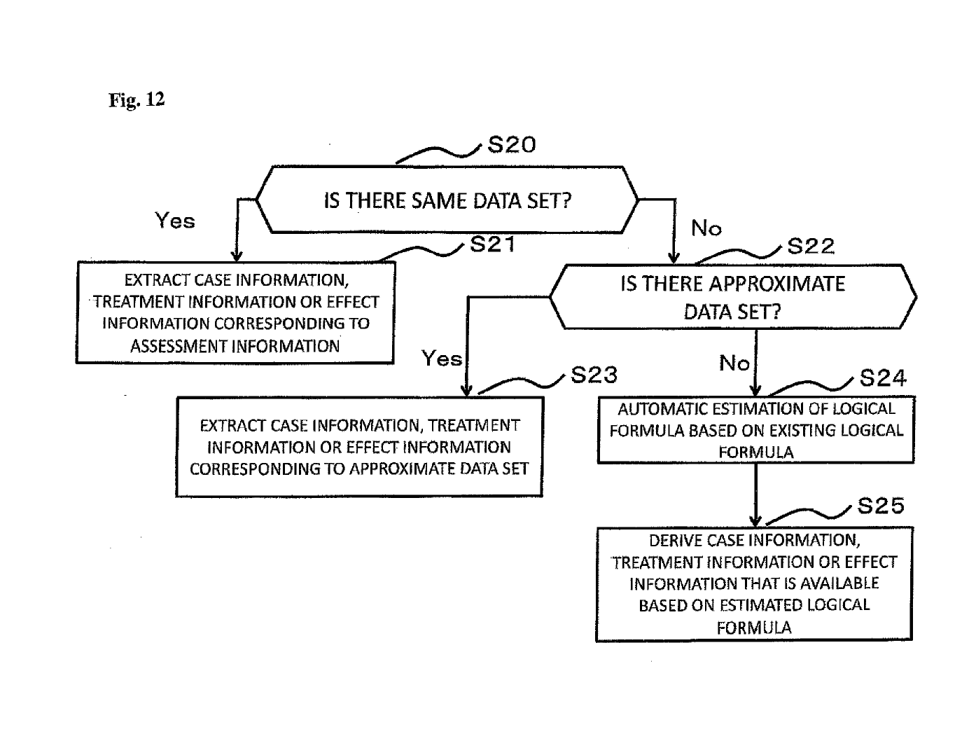

As shown in FIG. 12, whether the same data set information having the same contents as the input information is stored in the database 12 is determined (S20). Subsequently, when the same data set is stored in the database 12, at least one type of information among the case information, treatment information and effect information corresponding to that data set is output (S21). When the same data set is not stored in the database 12, whether there is an approximate data set is determined. Here, upon determining whether the data is approximate, the determination may be made based on the overall database (universal set) or partial data (subset). When the database 12 includes an approximate data set, at least one type of information among the case information, treatment information and effect information corresponding to the assessment information is output (S23). When the database 12 does not include an approximate data set, automatic estimation is performed based on the database 12. For example, the logical expression is automatically estimated based on the existing logical expression, and one type of information among the case information, treatment information and effect information that is available based on the estimated logical expression is derived (S25). Upon performing the automatic estimation, as shown in FIG. 10, the automatic estimation may be performed by referring to the reference database. The reference database stores, for example, human data, engineering data, scientific data, medical data, academic data, industrial data, philosophical data, historical data, social science data, natural science data, technical data, trade data, artistic data, language data, and literary data.

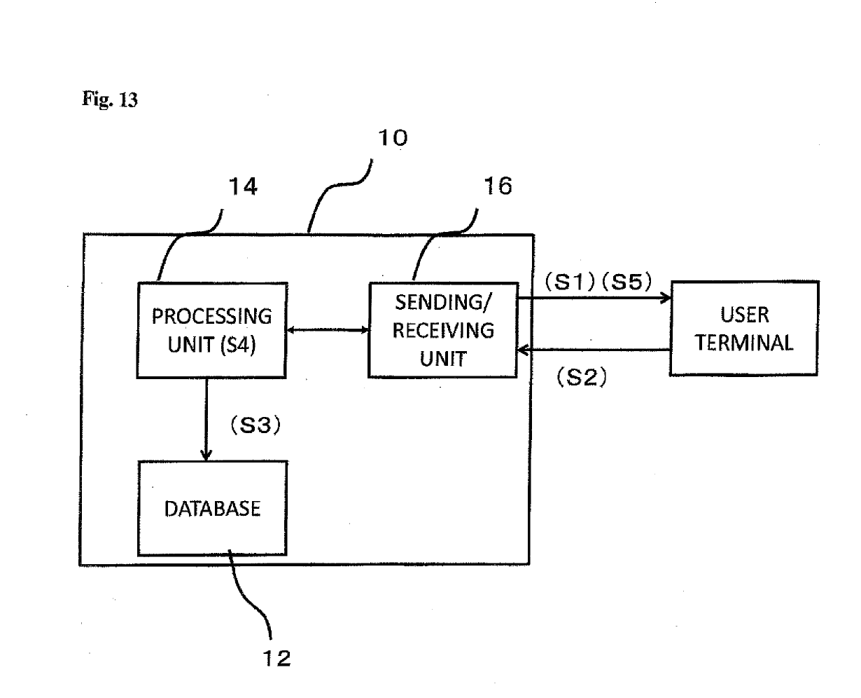

The method of acquiring the assessment contents is now explained with reference to FIG. 13.

Foremost, the processing unit derives the assessment items of a subject of care or an object of care from the database, and sends the assessment items to the user terminal 20. The assessment item may be an assessments item of Yes/No or the like that demands a binary answer, or an assessment item of multiple choice which demands an answer to be selected from 3 or more choices.

Subsequently, the subsequent assessment item is derived based on the previously assessed contents, the input or received answer to the assessment item, and correspondence data of the answer pattern of the assessment contents stored in the database 12 and the case information, treatment information or effect information. It is thereby possible to perform assessment that is appropriate for the subject of care or the like rather than performing the assessment according to predetermined contents and order, and the assessment can be performed efficiency and accurately. That is, the subsequent assessment item which is deemed capable of identifying the symptom with the shortest route is selected from an aggregate of selectable assessment items in order to identify the detailed symptom. To put it differently, the assessment item capable of minimizing the aggregate of choices of the subsequent assessment item onward is selected.

Specifically, as shown in FIG. 13, the processing unit 14 derives the assessment (history taking) contents and sends the assessment contents to the user terminal 20 via the sending/receiving unit 16 (S1), receives the answer of the assessment (history taking) (S2), accesses the database based on the received answer to acquire the necessary information (S3), derives how to deal with the subsequent assessment content after acquiring the necessary information (S4), and sends the subsequent answer to the user terminal (S5).

In addition, the case information, treatment information or effect information of the subject of care or the object of care can be derived from the database 12 based on the answer to the assessment (history taking) that was input or received as described above.

That is, when a certain assessment content is decided, choices that are available from past data are determined. An assessment item for further assessment is selected from the foregoing choices. Here, when an assessment item capable of minimizing the types of assessment items that may be selected in the assessment subsequent to this assessment is selected, the number of assessments required for identifying the case can be minimized.

The information processing device 10 may also receive additional information from the additional information terminal device 40, and send the additional condition or processing information thereof to the user terminal 20. Moreover, as shown in FIG. 6, it is also possible to receive the provision of information from an external reference data server 50 and use the received information for the foregoing information processing, or send the received information to the user terminal as additional information.

A program for causing the information processing device 10 to execute information processing may be stored in a storage device (for example, ROM, hard disk) or the like included in the information processing device 10. The foregoing information processing may be executed with an arithmetic unit such as a CPU. The database may be stored in a storage device such as a hard disk.

The user terminal 20 and the additional information input terminal 40 may be configured, for example, from a computer or a portable terminal such as a portable phone having an input/output function.

The information processing device may also be an automatic calculator such as a computer or a portable terminal such as a portable phone.

In the foregoing embodiment, the information processing device 10 was explained as a device that is connected to an information communication network such as the internet for sending and receiving information to and from the user terminal 20.

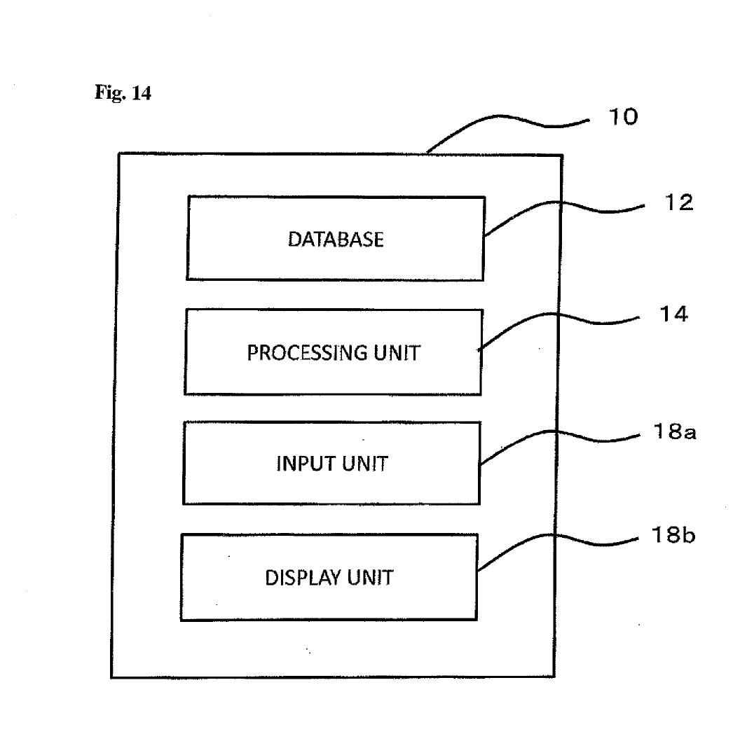

Nevertheless, without limitation to the above, as shown in FIG. 14, the information processing device 10 may independently comprise an input unit 18a and a display unit 18b so that the information processing can be completed with the information processing device 10 alone. In the foregoing case, display means may be provided to the information processing device for displaying the case information and treatment information.

5. Other information processing functions

The information processing device 10 may also include the following information processing functions.

(1) Means to be used as a reference upon finding the special characteristics of each region or the assessment items, or upon deriving the case information and treatment information may be added.

(2) Upon deriving the case information and treatment information based on the assessment contents, other data (for instance, MDS) may be used as a reference for assessing the reliability thereof.

(3) An annunciation device (alarm, display means or the like) for notifying an abnormality to the administrator of the information processing device when such an abnormality is discovered in the input actual symptom information or treatment information may be provided.

6. Data

The following items may also be acquired and stored in the database.

(1) Data regarding the vital signs and health condition of the subject of care may be acquired and stored in the database. As the vital signs, considered may be, for example, body temperature, blood pressure (high) systolic blood pressure, blood pressure (low) systolic blood pressure, pulse (/minute), respiration (/minute), Spoₜ blood oxygen saturation, height, weight, moisture content (cc) INPUT, moisture content (cc) OUTPUT, breakfast (amount of main dish), breakfast (amount of side dish), lunch (amount of main dish), lunch (amount of side dish), dinner (amount of main dish), dinner (amount of side dish), amount of snacks, defecation (times/month, urination (times/month), and so on.

As indexes for learning the health condition, considered may be, for example, complexion “whether the person looks well”, expression “whether the person feels well”, appetite “whether the person has appetite”, sleep “whether the person is sleeping well”, defecation “whether the person is constipated”, mood “whether the person feels pleasant, whether the person laughs often”, bathing “whether the person often takes a bath”, and so on.

(2) Related information of image data of the brain based on neuro-imaging such as MR1 and the symptom may be stored, and sent to or displayed on the user terminal as appropriate. That is, since the remaining portions of the brain neuron are captured from behavior observation, caregivers can also visually understand the pathology from a balance sheet (KBS: Kyomation Balance Sheet) of the functional map of the cell structure classification and the cerebral cortex. This balance sheet is used for checking “which part of the brain has been damaged” from the brain image, and comparing the result with the “symptoms of dementia” that are known from daily behavior observation. The existence of this information contributes the discovery of factors of BPSD (Behavioral Psychological Symptoms of Dementia) from the comprehension of the brain function (desires) based on image diagnosis and the behavior (maladjusted behavior) based on observation.

(3) A pattern graph of sleep and defecation may also be stored. A sleep/defecation pattern graph is a graph that shows, in a time series, the sleep/defecation pattern recorded for 168 hours (1 week) in 15-minute intervals in behavior observation. This pattern graph represents the sleep/defecation probability (number of days of sleep and number of days of defecation÷ number of days recorded×100) in each period of time. With conventional nursing care records, while it was difficult to visually examine the average sleep condition or defecation frequency, by viewing the time series variation and probability using a graph, it becomes possible to more visually and clearly comprehend the period of time that nocturnal awakening tends to occur and the desire to urinate tends to occur during the day. Moreover, based on this graph, it is also possible to visually capture and analyze the life rhythm, lift pattern and problems in the life of persons suffering from dementia.

Note that the recording by the caregiver (user) may be performed in the following order; namely, “subjective symptom (Subjective)”, “objective opinion (Objective)”, “assessment (Assessment)”, and “plan (Plan)”. Consequently, since descriptions based on problem-oriented thoughts are enabled, and physicians, clinical psychologists, caregivers, nurses, physiotherapists, speech therapists, musical therapists, occupational therapists and others can uniformly adopt this description method, uniform information can be exchanged between the teams.

6. Operation and effect

The present inventors discovered that appropriate care can be offered by rotating the “(D)F-PDCA cycle” of collect information (Data), analyze information (Focus), create plan (Plan), execute plan (Do), response to behavior/intervention (Response), assess result (Check), and review plan (Action).

Generally speaking, in the field of medical care, the method of devising and executing a plan is left up to the skills of the person creating the plan, and knowledge is not being systemized, and the creation of plans is not being approached from a scientific viewpoint.

According to this embodiment, information obtained from information collection is analyzed (Focus). That is, information is analyzed and associated with various types of information. In particular, what is unique about the present invention is that the present inventors discovered that the expression of the Behavioral Psychological Symptoms of Dementia can be suggested based on the combination of four types of logical circuits; namely, AND, nAND, OR, and nOR. The embodiment of the present invention is a system of storing these logic circuits in the database, deriving at which kind of content of the subsequent history taking is appropriate based on the logic circuits, and efficiently and accurately eliciting the case information and treatment information. Conventionally, items to be assessed were listed, and the case information could only be comprehended after assessing all assessment items. Nevertheless, since the assessment content and the treatment information are associated, the treatment information can be derived only by inputting the assessment items. Conventionally, the case information was recognized from the assessment contents, and the type of treatment information to be adopted was comprehend based on the individual ability of the person creating the care plan based on the foregoing case information. Nevertheless, according to this embodiment, since the treatment information of the subject of care can be learned only be performing the assessment operation, the treatment information can be created from the case information and the treatment information can be obtained only by inputting the assessment contents.

Since this system decides the assessment items that are deemed appropriate on a case-by-case basis rather than presenting the assessment items in a predetermined order of the assessment items, the assessment items related to education can also be derived, as appropriate, in addition to the assessment relating to medical care. That is, the present invention cross-functionally covers all fields such as medical, nursing, caring, education and sports. Moreover, based on the information collection and data sharing of the respective professionals, the generation mechanisms of the various symptoms of the subject of care can be accurately comprehended.

By referring to the logic circuits, it also becomes possible to comprehend an assessment item that is highly related to the assessment content of a certain assessment item.

The embodiment described above may be variously modified within the scope of the gist of this invention. While the foregoing embodiment mainly describes the care of dementia patients, the present invention is not limited thereto, and this invention can also be broadly applied to fields of education and mental care. Moreover, the present invention can also be broadly applied to the care of animals and plants in addition to the care of people.

### INDUSTRIAL APPLICABILITY

The present invention can be applied as a management system in personal care.

### DESCRIPTION OF REFERENCE NUMERALS

10 Information processing device

12 Database

14 Processing unit

16 Sending/receiving unit

18a Input unit

18b Display unit

20 User terminal

30 Acceptance server

40 Additional information input terminal

50 Reference data server

1. An information processing device, including:
a database which mutually associates assessment contents of a plurality of assessment items of a subject of care or an object of care with case information, treatment information or effect information of the subject of care or the object of care as one data set and stores the one data set;
a first processing unit which derives an assessment item of the subject of care or the object of care from the database;
a second processing unit which refers to the database and derives a subsequent assessment item in accordance with the assessment contents of the previously evaluated assessment item and the input or received assessment;
a third processing unit which derives case information, treatment information or effect information of the subject of care or the object of care from the database based on the input or received assessment contents; and
update means which updates the assessment contents of the previously evaluated assessment item and the input or received assessment, reply order of the assessment contents stored in the database, and the actually input case information, treatment information or effect information.

2. The information processing device according to claim 1,
wherein the database stores, for each data set, assessment contents, order of the assessment items that were evaluated, and a logic circuit for making decisions.

3. The information processing device according to claim 1,
wherein, when contents of a same assessment item are stored in the database, case information or treatment method of the subject of care or the object of care corresponding to the contents of that assessment item is extracted, and
wherein, when contents of a same assessment item are not stored in the database, case information or treatment method corresponding to contents of an assessment that is approximate to the contents of that assessment item is extracted.

4. The information processing device according to claim 1, further including:
estimation means which estimates anticipated assessment contents based on the input or received case information, treatment information or effect information.

5. The information processing device according to claim 1,
wherein, when the case information, treatment information or effect information derived based on the assessment contents and the actual case information, treatment information or effect information that was input or received are different, the actual case information, treatment information or effect information that was input or received is stored in the database.

6. An information processing method, including:
a step of a first processing unit deriving an assessment item of a subject of care or a object of care from a database which mutually associates assessment contents of a plurality of assessment items of the subject of care or the object of care with case information, treatment information or effect information of the subject of care or the object of care as one data set and stores the one data set;
a step of a second processing unit referring to the database and deriving a subsequent assessment item in accordance with the assessment contents of the previously evaluated assessment item and the input or received assessment;
a step of a third processing unit deriving case information, treatment information or effect information of the subject of care or the object of care from the database based on the input or received assessment contents; and
a step of update means updating the assessment contents of the previously evaluated assessment item and the input or received assessment, reply order of the assessment contents stored in the database, and the actually input case information, treatment information or effect information.

7. A non-temporary computer-readable recording medium with a program recorded thereon for causing a computer to execute:
a first step of a first processing unit deriving an assessment item of a subject of care or an object of care from a database which mutually associates assessment contents of a plurality of assessment items of the subject of care or the object of care with case information, treatment information or effect information of the subject of care or the object of care as one data set and stores the one data set;
a second step of the second processing unit referring to the database and deriving a subsequent assessment item in accordance with the assessment contents of the previously evaluated assessment item and the input or received assessment;
a third step of the third processing unit deriving case information, treatment information or effect information of the subject of care or the object of care from the database based on the input or received assessment contents; and
a step of update means updating the assessment contents of the previously evaluated assessment item and the input or received assessment, reply order of the assessment contents stored in the database, and the actually input case information, treatment information or effect information.
